(19) United States
(12) Patent Application Publication
(10) Pub. No.: US 2012/0039316 A1
(43) Pub. Date: Feb. 16, 2012

(54) METHOD OF GENERATING MAP, AND METHOD OF MEASURING LOCATION OF TERMINAL USING THE MAP

(75) Inventors: Do Hyung PARK, Seoul (KR); Eung Sun KIM, Suwon-si (KR); Sung Cheol KIM, Goyang-si (KR)

(73) Assignee: SAMSUNG ELECTRONICS CO., LTD.

(21) Appl. No.: 13/072,258

(22) Filed: Mar. 25, 2011

(30) Foreign Application Priority Data
Aug. 12, 2010 (KR) 10-2010-0077745

(51) Int. Cl. H04W 64/00

(52) U.S. Cl. 370/338

(57) ABSTRACT

A method of generating a map in a wireless network including a target device, at least two peripheral devices, and a terminal is provided. The target device may obtain relative location information of the at least two peripheral devices with respect to the target device, generate a local map of the target device based on the obtained relative location information, and share information associated with the local map of the target device with the at least two peripheral devices. The target device may further generate a reference map with respect to the target device and the at least two peripheral devices using the local map of the target device and local maps of the at least two peripheral devices, and provide, to the terminal, information associated with the reference map.

### CROSS-REFERENCE TO RELATED APPLICATION(S)

This application claims the benefit under 35 U.S.C. §119(a) of Korean Patent Application No. 10-2010-0077745, filed on Aug. 12, 2010, in the Korean Intellectual

Property Office, the entire disclosure of which is incorporated herein by reference for all purposes.

### BACKGROUND

1. Field

The following description relates to a method of generating a map and a method of measuring a location of a terminal using the map.

2. Description of Related Art

A network map is a tool used in determining the physical connectivity of elements within a network. Mapping may be used to enhance the understanding of relationships between various network elements and may also be used to aid in identifying bottlenecks in the network.

A location measurement technology within in a network includes a technology of measuring a location of a mobile terminal. A location measurement result may be used to provide a variety of services in the mobile terminal and in forming the map.

A proximity scheme of being proximate to a location of a wireless fidelity (Wi-Fi) access point connected in a wireless local area network (WLAN) environment may be employed to estimate a location of a terminal.

In the case of a global positioning system (GPS) scheme using terminals installed with a GPS chip set, a proximity scheme of being proximate to a location of a cell base station including the terminal may receive a satellite signal to estimate the location.

Accordingly, it is possible to measure a location indoors.

Due to a relatively large location interval between base stations, location estimation technologies using the cell base station may have a relatively large error in location estimation.

A location estimation technology using a WLAN may assume a circumstance where WLAN access points are sufficiently clustered. However, access points are generally designed for communication and information transmission and thus, may not be sufficiently clustered.

It may be assumed that the location estimation technology using the WLAN is aware of locations of WLAN access points desired to be used for a reference point. However, costs may be used to accurately calculate the locations of the WLAN access points. A map storing the reference point may need to be manually managed using the manpower.

### SUMMARY

In one general aspect, a method of generating a map in a wireless network including a target device, at least two peripheral devices, and a terminal, includes obtaining, by the target device, relative location information of the at least two peripheral devices with respect to the target device, generating, by the target device, a local map of the target device based on the obtained relative location information, sharing, by the target device, information associated with the local map of the target device with the at least two peripheral devices, generating, by the target device, a reference map with respect to the target device and the at least two peripheral devices using the local map of the target device and local maps of the at least two peripheral devices, and providing, by the target device to the terminal, information associated with the reference map.

The method may further include forming a network topology for the wireless network based on information stored in the local map of the target device and the local maps of the at least two peripheral devices.

The generating of the reference map may include generating the reference map using the network topology for the wireless network.

The obtaining of the relative location information may include obtaining, by the target device, the relative location information based on one of a time of arrival (TOA) between the target device and the at least two peripheral devices, a time difference of arrival (TDOA), and a received signal strength indicator (RSSI).

Each of the target device and the at least two peripheral devices may correspond to a device with a communication function fixed in a predetermined space of the wireless network or an access point for the wireless network.

The method may further include broadcasting absolute location information of one of the target device and the at least two peripheral devices, and calculating a location of each of the target device and the at least two peripheral devices based on the absolute location information.

The obtaining of the relative location information may include obtaining, by the target device, the relative location information based on distance information between the target device and the at least two peripheral devices that is broadcast from the at least two peripheral devices.

The local map may include one of the relative location information between the target device and the at least two peripheral devices, and information associated with the target device and the at least two peripheral devices.

In another general aspect, a method of measuring a location of a terminal using a map in a wireless network including a target device, at least two peripheral devices, and the terminal, includes requesting, by the terminal, one of the target device and the at least two peripheral devices for a reference map with respect to the target device and the at least two peripheral devices, receiving, by the terminal, the reference map from one of the target device and the at least two peripheral devices in response to the request, and calculating, by the terminal, the location of the terminal based on the reference map.

The method may further include receiving, by the terminal, absolute location information with respect to one of the target device and the at least two peripheral devices, and calculating an absolute location of the terminal based on the absolute location information.

The calculating of the location of the terminal may include calculating the location of the terminal based on one of a time of arrival (TOA) between the terminal and the target device or the at least two peripheral devices, a time difference of arrival (TDOA), and a received signal strength indicator (RSSI), using the reference map.

In still another general aspect, a method of generating a map in a wireless network including a target device, at least two peripheral devices, and a terminal includes receiving, by the target device, relative location information between the target device and the at least two peripheral devices, gathering, by the target device, the relative location information between the target device and the at least two peripheral devices, and information associated with the target device and the at least two peripheral devices, generating, by the target device, based on the gathered information, a reference map for measuring a location of the terminal in the wireless network, and providing, by the target device, to the terminal, information associated with the reference map.

The method may further include measuring, by the target device, a distance between the target device and the at least two peripheral devices.

The measuring may include measuring the distance between the target device and the at least two peripheral devices based on one of a time of arrival (TOA) between the target device and the at least two peripheral devices, a time difference of arrival (TDOA), and a received signal strength indicator (RSSI).

Each of the target device and the at least two peripheral devices may correspond to a device with a communication function fixed in a predetermined space of the wireless network or an access point for the wireless network.

In still another general aspect, a method of generating a map in a wireless network comprising a target device and at least two peripheral devices includes obtaining, by the target device, relative location information of the at least two peripheral devices with respect to the target device, generating, by the target device, a local map of the target device based on the obtained relative location information, sharing, by the target device, information associated with the local map of the target device with the at least two peripheral devices, and generating, by the target device, a reference map with respect to the target device and the at least two peripheral devices using the local map of the target device and local maps of the at least two peripheral devices.

Other features and aspects will be apparent from the following detailed description, the drawings, and the claims.

### BRIEF DESCRIPTION OF THE DRAWINGS

FIG. 1 is a diagram illustrating an example of a network where devices form a map through measurement of a distance between the devices.

FIG. 2 is a diagram illustrating an example of a method of generating a map.

FIG. 3 is a diagram illustrating an example of generating, by devices within a wireless network, a local map to calculate a relative location.

FIGS. 4A through 4D are diagrams illustrating an example of a process of generating, by devices within a wireless network, a network topology.

FIG. 5 is a diagram illustrating an example of calculating, by each of devices within a wireless network, a location of a corresponding device when a network topology of the wireless network is formed.

FIG. 6 is a diagram illustrating an example of a method of measuring a location of a terminal using a map.

FIG. 7 is a diagram illustrating another example of a method of generating a map.

FIG. 8 is a diagram illustrating an example of managing, by a single device within a wireless network, a reference map of the entire wireless network.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following detailed description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, description of well-known functions and constructions may be omitted for increased clarity and conciseness.

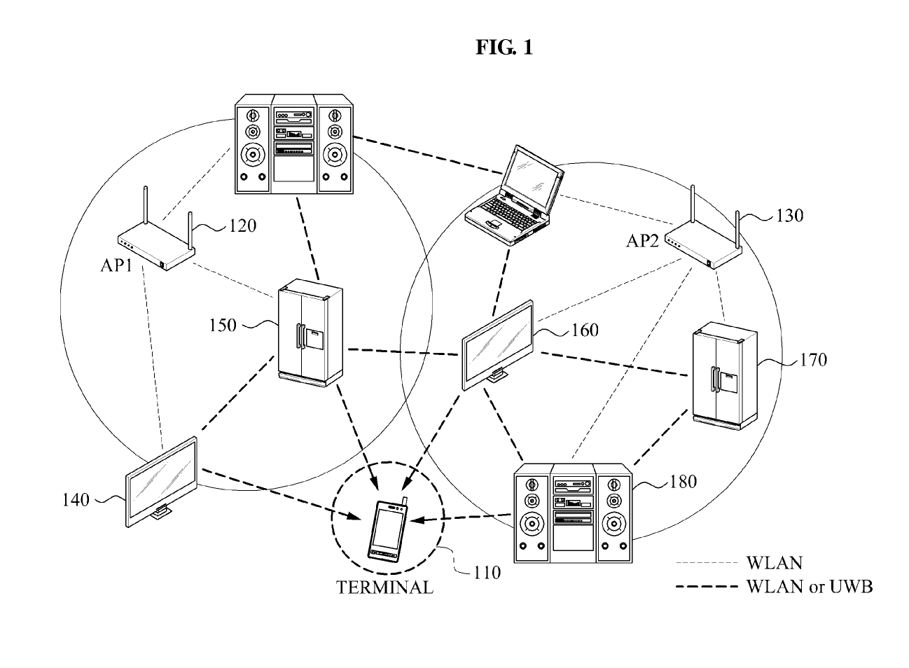

FIG. 1 illustrates an example of a network where devices form a map through measurement of a distance between the devices.

Referring to the example shown in FIG. 1, the network includes a terminal 110, a first access point (AP1) 120, a second access point (AP2) 130, and devices 140, 150, 160, 170, and 180 using a WLAN.

A variety of devices, in addition to a computer or a mobile terminal, may access the WLAN. For example, a WLAN technology may be installed in an electronic device such as a desktop PC, a TV, a fridge, an audio component, an air conditioner, and the like.

Accordingly, in the case of an electronic device using the WLAN, even though a plurality of WLAN access points (also referred to as “access points”) may not exist within a wireless network, it is possible to sufficiently provide a location measurement of a terminal by connecting access points with devices using the WLAN.

In the example of FIG. 1, a thin dotted line indicates a network connected using the WLAN, and a bold dotted line indicates a network connected using the WLAN or an ultra wide band (UWB). In addition to the WLAN and the UWB, the network may be formed using various types of wireless communication technologies.

Each of the AP1 120, the AP2 130, and the devices 140, 150, 160, 170, and 180 may correspond to a fixed node within the wireless network, and may generate a local map or a reference map using an ad hoc scheme and the like, for recognizing a location by measuring a mutual distance between connected nodes in the network.

Referring to FIG. 1, each of the AP1 120, the AP2 130, and the devices 140, 150, 160, 170, and 180 may automatically construct the local map or the reference map for recognizing a location through distance measurement and information exchange. A distance between each of the AP1 120 and the AP2 130 and each of the devices 140, 150, 160, 170, and 180 may be measured using a variety of schemes.

For example, in the case of the WLAN, a distance between each device and each access point may be measured using a two way ranging-time of arrival (TWR-TOA) in a link between each access point and each device, and between devices. The distance may be measured using a received signal strength indicator (RSSI) in all the links. However, these schemes are described only as examples. Other suitable may schemes may be employed as well.

In the case of the UWB, the distance may be measured using a TWR-TOA between access points and devices. However, other suitable schemes may be employed as well. That is, the TWR-TOA scheme is described for the purposes of example only, and the subject matter of the present application is not limited strictly thereto.

As described above, by performing, by each of access points and devices within the wireless network, corresponding distance measurement and information exchange, each of the devices may automatically generate a reference map without a need for a user to directly measure a location of each of the devices. Devices recognizing their own location may be used as reference points for indoor location measurement.

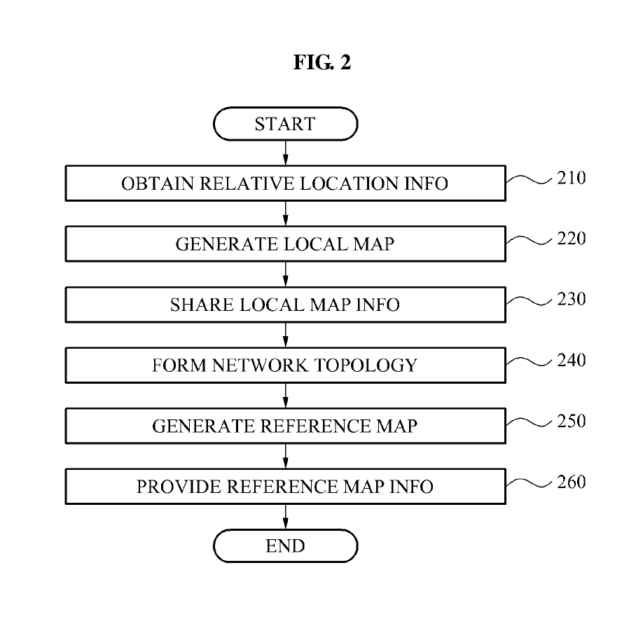

FIG. 2 illustrates an example of a method of generating a map.

Referring to the example FIG. 2, in a wireless network including a target device, at least two peripheral devices, and a terminal, the target device may obtain relative location information of the at least two peripheral devices with respect to the target device.

For example, the target device may obtain the relative location information based on one of a TOA between the target device and the at least two peripheral devices, a TDOA, and an RSSI.

The TOA may obtain location information using a difference of a signal arrival time between the target device receiving a signal of the terminal and the at least two peripheral devices.

The TDOA may measure a signal delay of the at least two peripheral devices based on a signal of the target device. A plurality of hyperbolic curves may be generated based on a time difference of arrival between the signal of the target device and signals of the at least two peripheral devices. An intersecting point of the hyperbolic curves may be estimated as the location of the terminal.

The RSSI may estimate the location of the terminal using a strength of the signal received by each of the target device and the at least two peripheral devices from the terminal.

The target device may also obtain the relative location information based on distance information between the target device and the at least two peripheral devices, where the distance information is broadcast from the at least two peripheral devices.

Each of the target device and the at least two peripheral devices may correspond to a device with a communication function fixed in a predetermined space of the wireless network or an access point for the wireless network.

Each of the target device and the at least two peripheral devices may calculate a corresponding location, and store the calculated location.

The device with the communication function may be an electronic device installed with a WLAN technology, for example, a desktop PC, a TV, a fridge, an air conditioner, and the like. However, the device with the communication function is not limited to examples listed above.

In operation 220, the target device generates a local map of the target device based on the obtained relative location information.

The target device may generate the local map by measuring a distance from each of the at least two peripheral devices.

For example, it may be assumed that among devices A, B, and C included in a wireless network, the device A corresponds to a target device, and the devices B and C correspond to peripheral devices. Here, it may be assumed that a distance between the devices A and B is 3 m, for example, a distance between the devices A and C is 5 m, for example, and a distance between the devices B and C is 4 m, for example.

The device A corresponding to the target device may store, in a local map, the value 3 m that is relative location information between the device A and the device B corresponding to a peripheral device linked to the device A, and may also store, in the local map, the value 5 m that is relative location information between the device A and the device C corresponding to another linked peripheral device.

Similarly, each of the devices B and C may store, in a corresponding local map, relative location information from the linked target device or peripheral devices.

In operation 230, the target device shares information associated with the local map of the target device with the at least two peripheral devices. By sharing local map information, all the devices included in the wireless network may include, in corresponding local maps, relative location information of all the devices included in the wireless network.

The target device may update the local map by sharing or exchanging information associated with the local map with the at least two peripheral devices. Here, the local map information may include the relative location information of the at least two peripheral devices. Similarly, each of the at least two peripheral devices may update a corresponding local map.

For example, the target device and the at least two peripheral devices may each update a corresponding local map using the following two schemes:

First, among devices, for example, the target device and the at least two peripheral devices within the wireless network, a device being aware of an absolute location of the device may inform neighboring devices about the absolute location.

Specifically, when absolute location information of one device among the target device and the at least two peripheral devices is broadcast, each of remaining devices may calculate a location of each of the remaining devices based on the absolute location information.

Each of the devices included in the wireless network may include relative location information of devices linked to a corresponding device and remaining devices. Accordingly, when absolute location information of one of the devices is known, any device may calculate an accurate location of a corresponding device based on the absolute location information and the relative location information stored in a corresponding local map.

In this example, the local map may include the relative location information and absolute coordinates or an absolute location of each of the devices.

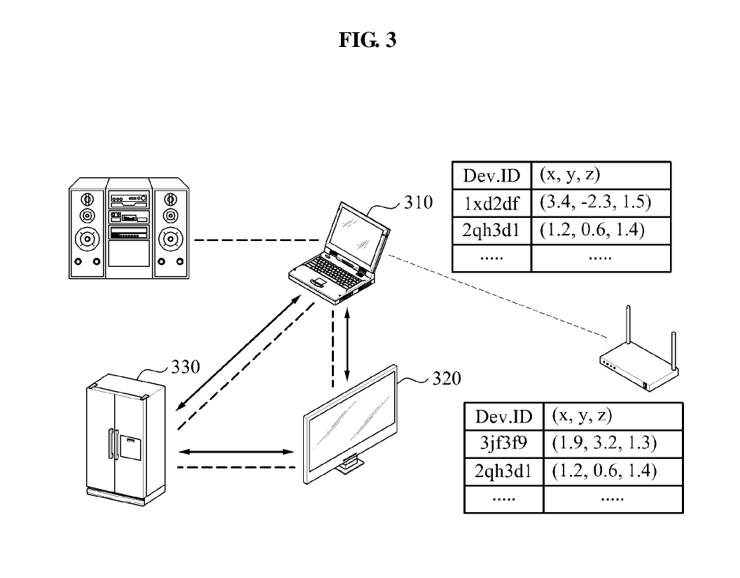

Second, when each of predetermined two devices included in the wireless network is aware of a distance from the same third device using a corresponding local map, a relative location may be calculated through triangulation as shown in the example illustrated in FIG. 3. An example of generating, by each of devices included in the wireless network, a local map to calculate a relative location is described further below with reference to FIG. 3.

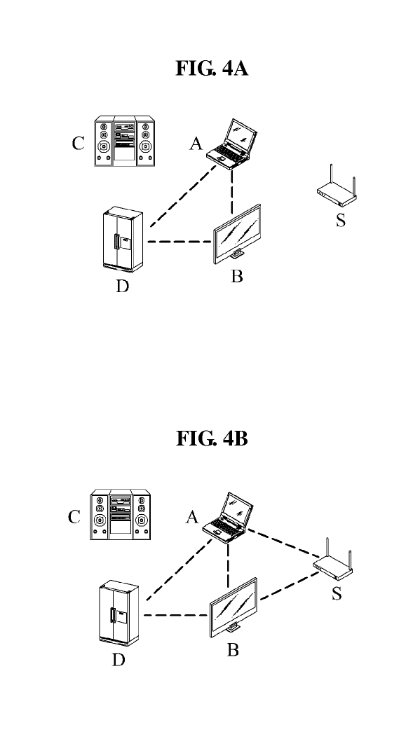

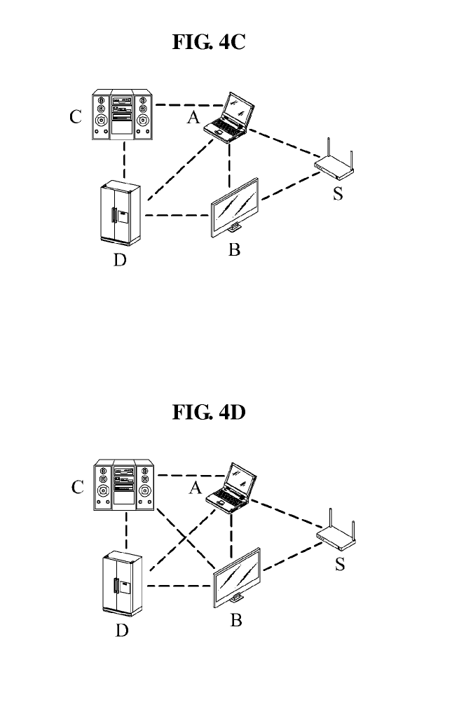

In operation 240, the target device forms a network topology for the wireless network based on information stored in the local map of the target device and the local maps of the at least two peripheral devices. A method of forming, by devices included in the wireless network, the network topology is described further below with reference to FIG. 4.

In operation 250, the target device generates a reference map with respect to the target device and the at least two peripheral devices using the local maps of the target device and local maps of the at least two peripheral devices.

The target device may generate the reference map using a network topology for the wireless network.

In operation 260, the target device provides, to the terminal, information associated with the reference map.

The method may also be performed without respect to the terminal or in a wireless network which does not include the terminal. That is, the target device may obtain relative location information of the at least two peripheral devices with respect to the target device in a wireless network including target device and at least two peripheral devices. This method may be performed as described above with respect to FIG. 2, with the exception of providing information associated with the reference map to the terminal.

FIG. 3 illustrates an example of generating, by each of devices within a wireless network, a local map to calculate a relative location.

Referring to the example in FIG. 3, the wireless network may include a target device 310 and at least two peripheral devices, for example, peripheral devices 320 and 330.

It may be assumed, for the purposes of this example, that an identifier (ID) of the target device 310 is 3jf3f9, an ID of the peripheral device 320 is 1xd2df, and an ID of the peripheral device 330 is 2qh3d1.

The target device 310 may generate a local map by measuring a distance from each of the peripheral devices 320 and 330 linked to the target device 310. The target device 310 may calculate a relative location based on a location of the target device 310, and may store the calculated relative location in the local map.

For example, the target device 310 may calculate coordinates (x, y, z) of the peripheral device 320 as (3.4, −2.3, 1.5) based on the location of the target device 310, and may store (3.4, −2.3, 1.5) in the local map. Similarly, the target device 310 may calculate (1.2, 0.6, 1.4) of the peripheral device 330 based on the location of the target device 310, and may store (1.2, 0.6, 1.4) in the local map.

In this example, the local map of the target device 310 may include at least one of information associated with the peripheral devices 320 and 330 linked to the target device 310, such as IDs of the peripheral devices 320 and 330, and the like, and relative location information between the target device 310 and the peripheral devices 320 and 330.

A local map of the peripheral device 320 may include information associated with the target device 310 and the peripheral device 330 linked to the peripheral device 320, relative location information between the peripheral device 320 and the target device 310, and relative location information between the peripheral devices 320 and 330.

The relative location information stored in the local map may include coordinates (x, y, z) as shown in FIG. 3, a distance from a corresponding device, for example, 5 m, and the like, and an angle based on the target device 310, and the like.

FIGS. 4A through 4D illustrate examples of a process of generating, by devices within a wireless network, a network topology.

Referring to the examples in FIG. 4, the devices within the wireless network may form the network topology by repeating a process of sharing a local map, which is described above with reference to FIG. 2.

For example, it may be assumed that a notebook A corresponds to a target device, and a TV B and a fridge D, having a communication function, correspond to peripheral devices. Hereinafter, the notebook A is also referred to as a target device A, and the TV B and the fridge D are also referred to as peripheral devices B and D.

In the example of FIG. 4a, the target device A shares or exchanges a local map with the peripheral devices B and D, and shares the local map with a neighboring access point S as shown in FIG. 4B. The peripheral device B also shares a local map with the access point S in the example of FIG. 4B.

As shown in the example of FIG. 4C, the target device A shares the local map with a neighboring audio component C. The peripheral device D adjacent to the target device A and the audio component C also shares a local map with the audio component C.

As shown in the example of FIG. 4D, the audio component C shares the local map with the peripheral device B adjacent to the target device A and the peripheral device D.

As described in the examples above, an access point and devices included in the wireless network may form a network topology for the wireless network by repeating mutual sharing or exchanging of the local map.

Each of the devices and the access point within the wireless network may include, in a corresponding local map, local map information associated with all the devices linked to a corresponding device within the wireless network.

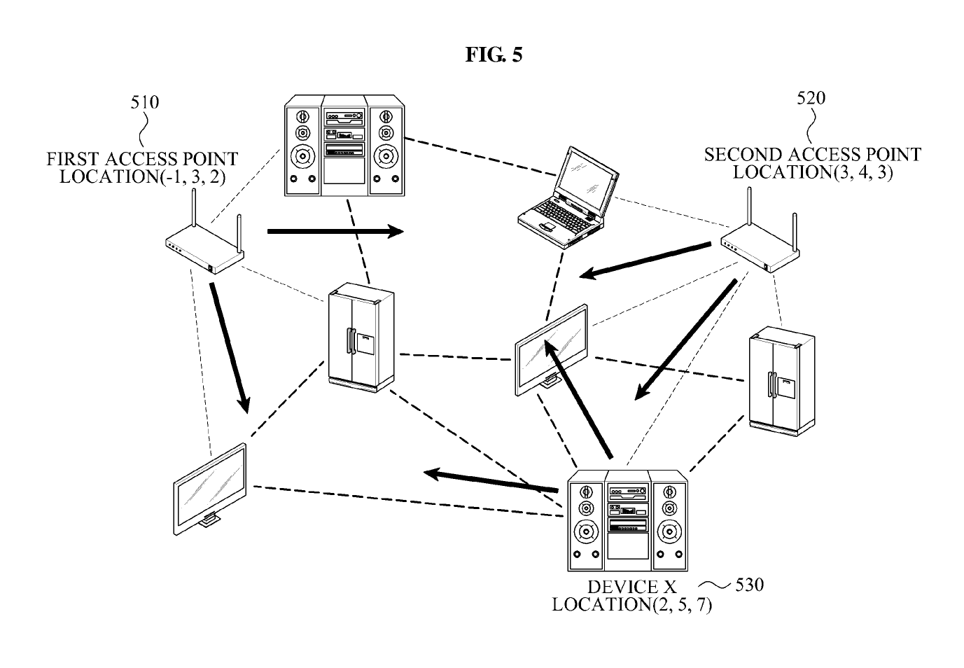

FIG. 5 illustrates an example of calculating, by each of devices within a wireless network, a location of a corresponding device when a network topology of the wireless network is formed.

Referring to the example in FIG. 5, the wireless network includes a first access point 510, a second access point 520, and a device X 530.

Each of the first access point 510, the second access point 520, and the device X 530 may store location information or a local map.

For example, when at least three devices, herein, the first access point 510, the second access point 520, and the device X 530 being aware of absolute location information within the network topology exist, the absolute location information or absolute coordinates may be broadcast within a corresponding network.

Referring to FIG. 5, each of the second access point 520, the device X 530, and other devices included in the network may calculate a location of its own and each of peripheral devices based on absolute location information of the first access point 510.

When the absolute location information broadcast from the first access point 510 is, for example, (−1, 3, 2), each of devices linked to the first access point 510 may calculate a corresponding absolute location using relative location information with respect to the first access point 510, based on the absolute location information of the first access point 510. The relative location information may be stored in a local map of each of the devices linked to the first access point 510.

Similar to the first access point 510, the second access point 520 having absolute location information, for example, (3, 4, 3), may broadcast the absolute location information (3, 4, 3) to the wireless network, and the device X 530 having absolute location information, for example, (2, 5, 7) may broadcast the absolute network information (2, 5, 7) to the wireless network. Similarly, each of devices linked to the second access point 520 and the device X 530 may calculate a corresponding location based on the absolute location information of the second access point 520 and the device X 530.

The above absolute location calculation method may be similarly applicable to a multi-dimensional method. For example, a two-dimensional (2D) method may use at least three devices being aware of absolute locations of the at least three devices, and a three-dimensional (3D) method may use at least four devices being aware of absolute locations of the at least four devices.

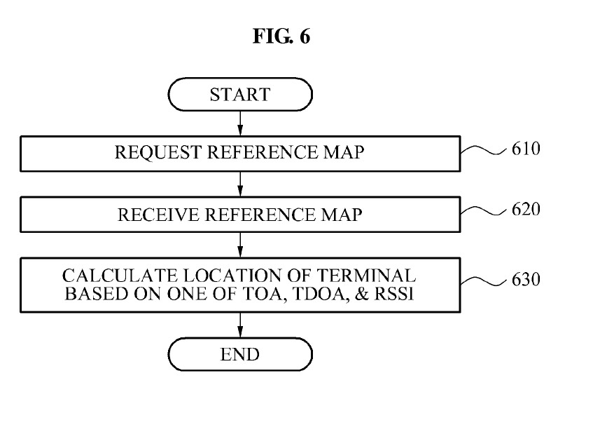

FIG. 6 illustrates an example of a method of measuring a location of a terminal using a map.

Referring to the example in FIG. 6, in a wireless network including a target device, at least two peripheral devices, and the terminal, the terminal requests one of the target device and the at least two peripheral devices for a reference map with respect to the target device and the at least two peripheral devices in operation 610.

In operation 620, the terminal receives the reference map from one of the target device and the at least two peripheral devices in response to the request.

In operation 630, the terminal calculates the location of the terminal using the reference map.

For example, using the reference map, the terminal may calculate the location of the terminal based on one of a TOA between the terminal and the target device or the at least two peripheral devices, a TDOA, and an RSSI.

The terminal may receive absolute location information associated with one of the target device and the at least two peripheral devices, and may calculate an absolute location of the terminal based on the absolute location information.

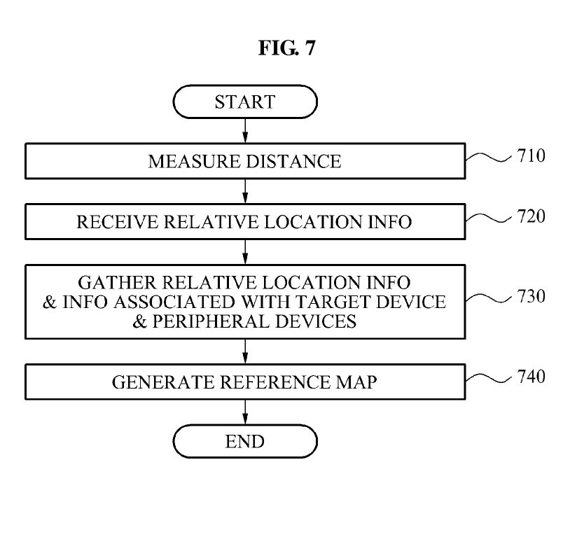

FIG. 7 illustrates another example of a method of generating a map.

Referring to the example in FIG. 7, in a wireless network including a target device, at least two peripheral devices, and a terminal, the target device measures a distance between the target device and the at least two peripheral devices in operation 710.

For example, the target device may measure the distance between the target device and the at least two peripheral devices based on one of a TOA between the target device and the at least two peripheral devices, a TDOA, and an RSSI.

In operation 720, the target device receives relative location information associated with the target device and the at least two peripheral devices.

Each of the target device and the at least two peripheral devices may correspond to a device with a communication function fixed in a predetermined space of the wireless network or an access point for the wireless network.

In operation 730, the target device gathers the relative location information between the target device and the at least two peripheral devices, and information associated with the target device and the at least two peripheral devices.

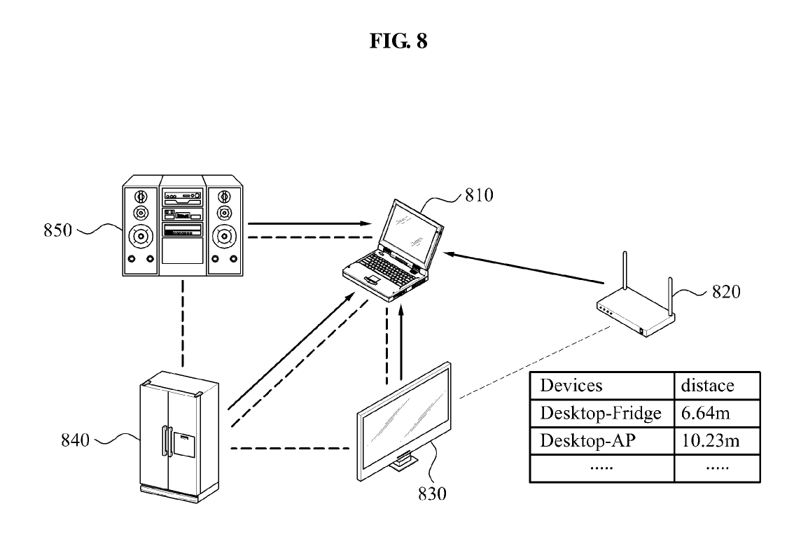

In operation 740, the target device generates, based on the gathered information, a reference map for measuring a location of the terminal in the wireless network. A process of generating, by the target device, and managing the reference map based on the gathered information is described below with reference to FIG. 8.

FIG. 8 illustrates an example of managing, by a single device within a wireless network, a reference map of the entire wireless network.

Referring to the example in FIG. 8, the wireless network includes a notebook 810, an access point 820, a TV 830, a fridge 840, and an audio component 850.

The notebook 810, the access point 820, the TV 830, the fridge 840, and the audio component 850 correspond to devices having a wireless communication function in this example.

Each of the devices included in the wireless network may measure a distance between a corresponding device and peripheral devices. In this instance, one of the devices may be a target device and receive distance information, including, for example, relative location information from the other devices.

For example, it may be assumed that the notebook 810 corresponds to a target device, and the access point 820, the TV 830, the fridge 840, and the audio 850 correspond to peripheral devices.

The notebook 810 corresponding to the target device may gather relative location information of at least two peripheral devices and information associated with the at least two peripheral devices, and may generate the reference map for measuring a location of the terminal in the wireless network.

For example, referring to FIG. 8, the notebook 810 corresponding to the target device may receive, from the peripheral devices, information regarding a distance or relative location information between the TV 830 and the fridge 840, a distance between the access point 820 and the TV 830, a distance between the notebook 810 and the desktop 830, a distance between the fridge 840 and the audio 850, and the like.

In this example, each of the peripheral devices included in the wireless network may provide, to the notebook 810 corresponding to the target device, a database containing relative location information between a corresponding device and other peripheral devices linked to the corresponding device.

The notebook 810 may construct a network topology of the wireless network based on a value obtained by measuring a distance between the notebook 810 and each of the peripheral devices, and the database received from the peripheral devices, and calculate the to location, and thereby generate the reference map as shown in FIG. 8.

According to the examples above, where a fixed device, for example, an electronic device, a laptop, a desktop PC, and the like, using a wireless local area network (WLAN) is used together with an access point, an accurate location measurement result with respect to a terminal may be provided in an environment where access points are not clustered enough to provide an accurate location measurement function.

According to the examples above, in an indoor environment where a global positioning system (GPS) may not be employed, it may be possible to accurately measure a location of a terminal using a WLAN.

According to examples above, each of devices included in a wireless network may automatically form a reference map used for a location measurement of a terminal and thus, it may be possible to more simply recognize the location of the terminal and to decrease a map formation cost.

The processes, functions, methods and/or software described above including a method of generating map and a method of measuring a location of a terminal using the map may be recorded, stored, or fixed in one or more non-transitory computer-readable storage media that includes program instructions to be implemented by a computer to cause a processor to execute or perform the program instructions. The media may also include, alone or in combination with the program instructions, data files, data structures, and the like. The media and program instructions may be those specially designed and constructed, or they may be of the kind well-known and available to those having skill in the computer software arts. Examples of non-transitory computer-readable media include magnetic media such as hard disks, floppy disks, and magnetic tape; optical media such as CD ROM disks and DVDs; magneto-optical media such as optical disks; and hardware devices that are specially configured to store and perform program instructions, such as read-only memory (ROM), random access memory (RAM), flash memory, and the like. Examples of program to instructions include both machine code, such as produced by a compiler, and files containing higher level code that may be executed by the computer using an interpreter. The described hardware devices may be configured to act as one or more software modules in order to perform the operations and methods described above, or vice versa. In addition, a non-transitory computer-readable storage medium may be distributed among computer systems connected through a network and non-transitory computer-readable codes or program instructions may be stored and executed in a decentralized manner.

As a non-exhaustive illustration only, and in addition to the various examples described above, a terminal device described herein may refer to mobile devices such as a cellular phone, a personal digital assistant (PDA), a digital camera, a portable game console, and an MP3 player, a portable/personal multimedia player (PMP), a handheld e-book, a portable lab-top PC, a global positioning system (GPS) navigation, and devices such as a desktop PC, a high definition television (HDTV), an optical disc player, a setup box, and the like capable of wireless communication or network communication consistent with that disclosed herein.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A method of generating a map in a wireless network comprising a target device, at least two peripheral devices, and a terminal, the method comprising:
obtaining, by the target device, relative location information of the at least two peripheral devices with respect to the target device;
generating, by the target device, a local map of the target device based on the obtained relative location information;
sharing, by the target device, information associated with the local map of the target device with the at least two peripheral devices;
generating, by the target device, a reference map with respect to the target device and the at least two peripheral devices using the local map of the target device and local maps of the at least two peripheral devices; and
providing, by the target device to the terminal, information associated with the reference map.

2. The method of claim 1, further comprising:
forming a network topology for the wireless network based on information stored in the local map of the target device and the local maps of the at least two peripheral devices.

3. The method of claim 2, wherein the generating of the reference map comprises generating the reference map using the network topology for the wireless network.

4. The method of claim 1, wherein the obtaining of the relative location information comprises obtaining, by the target device, the relative location information based on one of a time of arrival (TOA) between the target device and the at least two peripheral devices, a time difference of arrival (TDOA), and a received signal strength indicator (RSSI).

5. The method of claim 1, wherein each of the target device and the at least two peripheral devices corresponds to a device with a communication function fixed in a predetermined space of the wireless network or an access point for the wireless network.

6. The method of claim 1, further comprising:
broadcasting absolute location information of one of the target device and the at least two peripheral devices; and
calculating a location of each of the target device and the at least two peripheral devices based on the absolute location information.

7. The method of claim 1, wherein the obtaining of the relative location information comprises obtaining, by the target device, the relative location information based on distance information between the target device and the at least two peripheral devices that is broadcast from the at least two peripheral devices.

8. The method of claim 1, wherein the local map comprises one of the relative location information between the target device and the at least two peripheral devices, and information associated with the target device and the at least two peripheral devices.

9. A method of measuring a location of a terminal using a map in a wireless network comprising a target device, at least two peripheral devices, and the terminal, the method comprising:
requesting, by the terminal, one of the target device and the at least two peripheral devices for a reference map with respect to the target device and the at least two peripheral devices;
receiving, by the terminal, the reference map from one of the target device and the at least two peripheral devices in response to the request; and
calculating, by the terminal, the location of the terminal based on the reference map.

10. The method of claim 9, further comprising:
receiving, by the terminal, absolute location information with respect to one of the target device and the at least two peripheral devices; and
calculating, by the terminal, an absolute location of the terminal based on the absolute location information.

11. The method of claim 9, wherein the calculating of the location of the terminal comprises calculating the location of the terminal based on one of a time of arrival (TOA) between the terminal and the target device or the at least two peripheral devices, a time difference of arrival (TDOA), and a received signal strength indicator (RSSI), using the reference map.

12. A method of generating a map in a wireless network comprising a target device, at least two peripheral devices, and a terminal, the method comprising:
receiving, by the target device, relative location information between the target device and the at least two peripheral devices;
gathering, by the target device, the relative location information between the target device and the at least two peripheral devices, and information associated with the target device and the at least two peripheral devices;
generating, by the target device, based on the gathered information, a reference map for measuring a location of the terminal in the wireless network; and
providing, by the target device, to the terminal, information associated with the reference map.

13. The method of claim 12, further comprising:
measuring, by the target device, a distance between the target device and the at least two peripheral devices.

14. The method of claim 13, wherein the measuring comprises measuring the distance between the target device and the at least two peripheral devices based on one of a time of arrival (TOA) between the target device and the at least two peripheral devices, a time to difference of arrival (TDOA), and a received signal strength indicator (RSSI).

15. The method of claim 12, wherein each of the target device and the at least two peripheral devices corresponds to a device with a communication function fixed in a predetermined space of the wireless network or an access point for the wireless network.

16. A non-transitory computer-readable medium comprising a program for instructing a computer to perform the method of claim 1.

17. A method of generating a map in a wireless network comprising a target device and at least two peripheral devices, the method comprising:
obtaining, by the target device, relative location information of the at least two peripheral devices with respect to the target device;
generating, by the target device, a local map of the target device based on the obtained relative location information;
sharing, by the target device, information associated with the local map of the target device with the at least two peripheral devices; and
generating, by the target device, a reference map with respect to the target device and the at least two peripheral devices using the local map of the target device and local maps of the at least two peripheral devices.
